(19) United States
(12) Patent Application Publication
(10) Pub. No.: US 2024/0375716 A1
(43) Pub. Date: Nov. 14, 2024

(54) VEHICLE SIDE STRUCTURE

(71) Applicant: Honda Motor Co., Ltd., Tokyo (JP)

(72) Inventors: Hitomi YAMADA, Saitama (JP); Takeshi ABE, Saitama (JP); Takayuki SOMA, Tokyo (JP)

(73) Assignee: Honda Motor Co., Ltd., Tokyo (JP)

(21) Appl. No.: 18/635,037

(22) Filed: Apr. 15, 2024

(30) Foreign Application Priority Data
May 9, 2023 (CN) 202310514875.2

(51) Int. Cl. B62D 21/15; B60J 5/04; B62D 25/04

(52) U.S. Cl. CPC B62D 21/157; B60J 5/0431; B60J 5/0443; B62D 25/04

(57) ABSTRACT

A vehicle side structure includes: a pillar, provided on an outer side in a vehicle width direction, extending in a vehicle upper-lower direction, and formed in a hollow structure; a first stiffener, disposed inside the pillar and extending in the vehicle upper-lower direction; a second stiffener, disposed inside the pillar and on a lower side in the vehicle upper-lower direction, and having a length in the vehicle upper-lower direction shorter than that of the first stiffener; and a door hinge, bonded to a side surface of the pillar in the vehicle width direction. A lower end of the second stiffener in the vehicle upper-lower direction is bonded to the door hinge, and the second stiffener extends in the vehicle upper-lower direction to a position above the door hinge.

### CROSS-REFERENCE TO RELATED APPLICATION

This application claims the priority benefit of China application no. 202310514875.2, filed on May 9, 2023. The entirety of the above-mentioned patent application is hereby incorporated by reference herein and made a part of this specification.

### BACKGROUND

### Technical Field

The invention relates to a vehicle side structure.

### Description of Related Art

In order to allow the elderly, disabled people, children and other vulnerable groups to enjoy a sustainable transportation system, efforts have been devoted to provide vehicles with favorable vehicle body rigidity. According to conventional techniques, when a side collision occurs, in order to control a vehicle pillar to deform at a specific position, an assembly method for a large difference in rigidity has been designed. But this also leads to excessive deformation that results in undesirable cracks in components. The invention aims to improve vehicle safety performance and provide a sustainable transportation system.

### SUMMARY

A vehicle side structure according to an aspect of the invention includes: a pillar, provided on an outer side in a vehicle width direction, extending in a vehicle upper-lower direction, and formed in a hollow structure; a first stiffener, disposed inside the pillar and extending in the vehicle upper-lower direction; a second stiffener, disposed inside the pillar and on a lower side in the vehicle upper-lower direction, and having a length in the vehicle upper-lower direction shorter than that of the first stiffener; and a door hinge, bonded to a side surface of the pillar in the vehicle width direction. A lower end of the second stiffener in the vehicle upper-lower direction is bonded to the door hinge, and the second stiffener extends in the vehicle upper-lower direction to a position above the door hinge.

To make the above-mentioned features and advantages of the invention more obvious and understandable, embodiments are given below and described in detail with reference to the accompanying drawings.

### BRIEF DESCRIPTION OF THE DRAWINGS

FIG. 1 is a schematic partial side view illustrating a vehicle side structure according to an embodiment of the invention.

FIG. 2 is a schematic partial side view after the vehicle side structure of FIG. 1 hides a pillar outer member.

FIG. 3 is a schematic partial side view after the vehicle side structure of FIG. 1 hides a pillar inner member.

FIG. 4 is a top cross-sectional view taken along an A-A line and illustrating the vehicle side structure of FIG. 1.

FIG. 5 is a schematic perspective view illustrating the vehicle side structure of FIG. 4 from another perspective.

### DESCRIPTION OF THE EMBODIMENTS

The invention provides a vehicle side structure able to prevent excessive deformation that leads to cracks of a pillar.

A vehicle side structure according to an aspect of the invention includes: a pillar, provided on an outer side in a vehicle width direction, extending in a vehicle upper-lower direction, and formed in a hollow structure; a first stiffener, disposed inside the pillar and extending in the vehicle upper-lower direction; a second stiffener, disposed inside the pillar and on a lower side in the vehicle upper-lower direction, and having a length in the vehicle upper-lower direction shorter than that of the first stiffener; and a door hinge, bonded to a side surface of the pillar in the vehicle width direction. A lower end of the second stiffener in the vehicle upper-lower direction is bonded to the door hinge, and the second stiffener extends in the vehicle upper-lower direction to a position above the door hinge.

According to an embodiment of the invention, the vehicle side structure further includes: a first door beam, extending in a vehicle front-rear direction and connected with the door hinge; and a second door beam, extending in the vehicle front-rear direction, and bonded to the side surface of the pillar in the vehicle width direction at a position below the door hinge in the vehicle upper-lower direction. From a viewing perspective in the vehicle width direction, the second door beam is away from or partially overlapped with the lower end of the second stiffener.

According to an embodiment of the invention, an upper part of the first stiffener extends in the vehicle upper-lower direction to a roof rail extending in the vehicle front-rear direction, and a lower part of the first stiffener extends in the vehicle upper-lower direction to a position below the second door beam.

According to an embodiment of the invention, the first stiffener includes bonding parts, the bonding parts are bonded to front and rear surfaces of an inner part of the pillar in the vehicle front-rear direction, and the bonding parts are disposed to be away from the second stiffener, and, from a viewing perspective in the vehicle width direction, the bonding parts are overlapped with the second door beam.

According to an embodiment of the invention, lateral strips are formed on front and rear surfaces of the first stiffener in the vehicle front-rear direction, the lateral strips are disposed above and below the second stiffener and extend in the vehicle width direction, and the lateral strips include the bonding parts.

According to an embodiment of the invention, the vehicle side structure further includes: a patch, bonded to the second door beam on an outer side of the pillar in the vehicle width direction. The first stiffener further includes a protrusion part, and the protrusion part protrudes toward an outer side in the vehicle width direction on a periphery of the patch.

According to an embodiment of the invention, an upper strip is formed on a side surface of the first stiffener in the vehicle width direction, and the upper strip is disposed above the second stiffener in the vehicle upper-lower direction and extends in the vehicle upper-lower direction.

According to an embodiment of the invention, the first stiffener includes a flange part, the flange part is disposed above the second stiffener in the vehicle upper-lower direction, and extends in the vehicle front-rear direction, the pillar includes a pillar inner member and a pillar outer member, and the flange part is bonded to the pillar inner member and the pillar outer member.

According to an embodiment of the invention, a side surface of the pillar in the vehicle width direction includes an insertion hole, and the insertion hole is formed above the door hinge in the vehicle upper-lower direction, and the second stiffener extends to a position above the insertion hole in the vehicle upper-lower direction.

According to an embodiment of the invention, the lower end of the second stiffener includes a lower surface, and the lower surface is formed to be bent toward an inner side of the pillar.

In view of the foregoing, in the vehicle side structure of the invention, when a side collision occurs, the first stiffener extending in the vehicle upper-lower direction is able to suppress the deformation amount and the occurrence of cracks or breakage of the pillar. In addition, since the lower end of the second stiffener is overlapped with the door hinge in the vehicle width direction, the load when a side collision occurs can be taken by the second stiffener with a higher rigidity. Accordingly, the second stiffener extends to a position above the door hinge and is able to prevent an upper part of the door hinge from being bent or deformed and form a region that is easy to deform (rigidity difference) at a part below the door hinge, that is, a lower part at the lower end of the second stiffener, to ensure the deformation of the pillar occurs at the lower side. Accordingly, the vehicle side structure according to the invention is able to prevent excessive deformation that leads to cracks of the pillar.

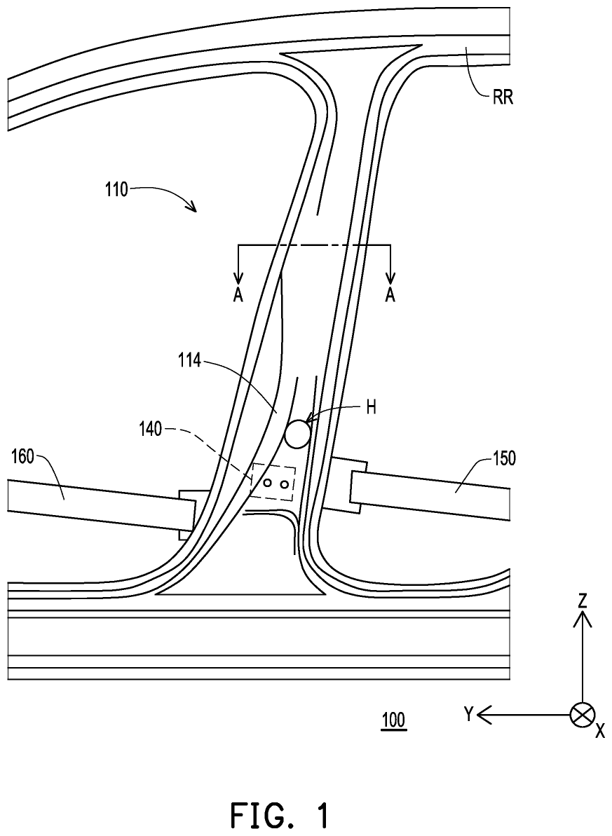

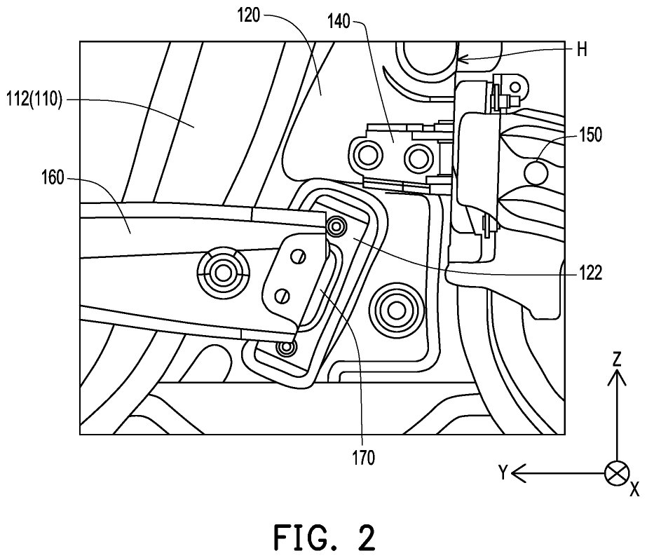

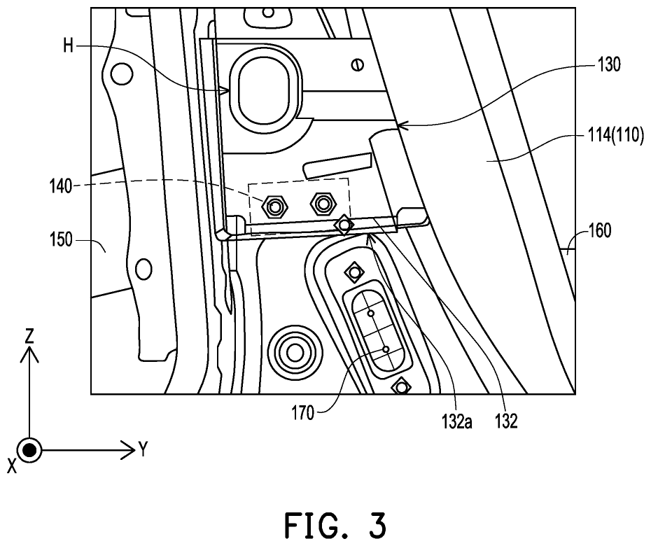

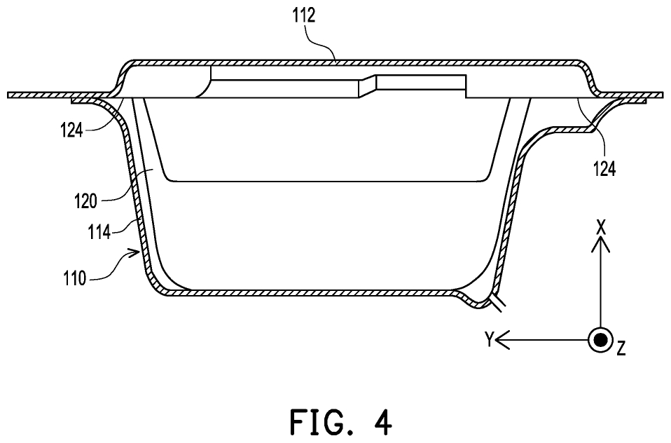

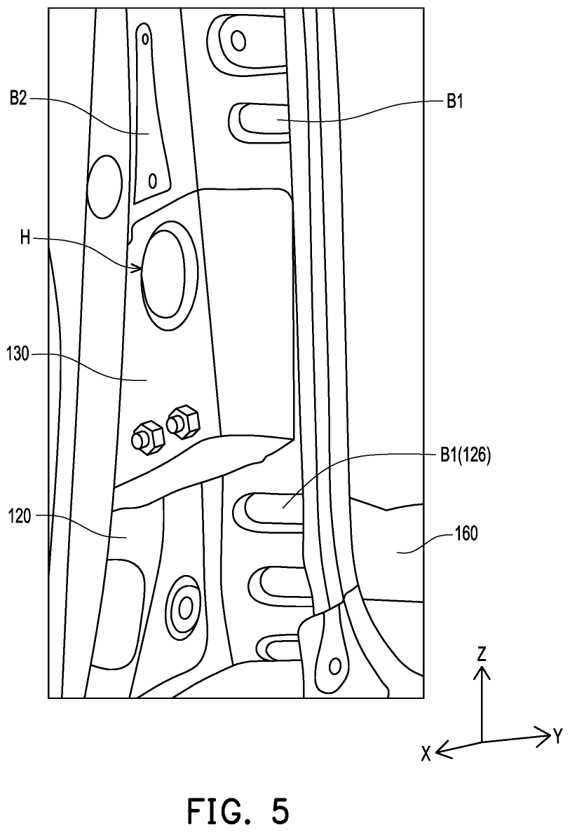

FIG. 1 is a schematic partial side view illustrating a vehicle side structure according to an embodiment of the invention. FIG. 2 is a schematic partial side view after the vehicle side structure of FIG. 1 hides a pillar outer member. FIG. 3 is a schematic partial side view after the vehicle side structure of FIG. 1 hides a pillar inner member. FIG. 4 is a top cross-sectional view taken along an A-A line and illustrating the vehicle side structure of FIG. 1. FIG. 5 is a schematic perspective view illustrating the vehicle side structure of FIG. 4 from another perspective. In the embodiment, a vehicle side structure 100 is, for example, a side structure applied to a conventional passenger car (not shown). However, the invention is not limited thereto. The vehicle side structure 100 may also be applied to other similar structures. In addition, since the left and right side of the vehicle body are substantially structurally symmetric, only one side of the vehicle is described in the following for the case of description. The vehicle width direction X, the vehicle front-rear direction Y, and the vehicle upper-lower direction Z in the drawings shall not be construed as limitations on the positional relationships among the respective components in the invention. In addition, unless otherwise specified, the inner side, the front side, and the upper side used in the following description respectively refer to the directions indicated by the arrow signs of the vehicle width direction X, the vehicle front-rear direction Y, and the vehicle upper-lower direction Z. The outer side, the rear side, and the lower side used in the following description respectively refer to directions opposite thereto. Where possible, like or similar reference symbols are used to represent like or similar parts in the accompanying drawings and the specification. In the following, the vehicle side structure 100 of the embodiment will be described in detail with reference to FIGS. 1 to 5.

Referring to FIGS. 1 to 3, in the embodiment, the vehicle side structure 100 includes a pillar 110, a first stiffener 120, a second stiffener 130, and a door hinge 140. The pillar 110 is provided on the outer side in the vehicle width direction X and extends in the vehicle upper-lower direction Z. In addition, the pillar 110 is formed in a hollow structure. Specifically, as shown in FIG. 4, the pillar 110 includes a pillar inner member 112 and a pillar outer member 114. The pillar inner member 112 is formed in a hat shape with an opening facing the outer side in the vehicle width direction X. The pillar outer member 114 is formed in a hat shape with an opening facing the inner side in the vehicle width direction X. The pillar inner member 112 and the pillar outer member 114 are bonded in the vehicle width direction X to form a hollow structure. The first stiffener 120 is formed inside the pillar 110 and extends in the vehicle upper-lower direction Z (as shown in FIG. 2). The second stiffener 130 is formed inside the pillar 110 on the lower side in the vehicle upper-lower direction Z. In addition, the length of the second stiffener 130 is formed to be shorter than the first stiffener 120 (see FIG. 3, for example). More specifically, the second stiffener 130 is assembled to cover the lower side and the inner side of the first stiffener 120, for example. That is, the lower side of the pillar 110 is assembled so that the pillar inner member 112, the second stiffener 130, the first stiffener 120, and the pillar outer member 114 are arranged in order from the inner side toward the outer side in the vehicle width direction X. The door hinge 140 is bonded to the side surface of the pillar 110 in the vehicle width direction X (e.g., the side surface of the pillar outer member 114, but the invention is not limited thereto).

Specifically, as shown in FIGS. 2 and 3, the second stiffener 130 is bonded to the door hinge 140 at a lower end 132 in the vehicle upper-lower direction Z. Specifically, the edge of the lower end 132 of the second stiffener 130 and the lower edge of the door hinge 140 are arranged in parallel by being aligned in the vehicle width direction X. However, the invention is not limited thereto. In addition, the second stiffener 130 extends to a position above the door hinge 140 in the vehicle upper-lower direction Z. That is, from the viewing perspective in the vehicle width direction X (i.e., the perspective of FIGS. 2 and 3), the second stiffener 130 and the door hinge 140 are overlapped, and the region of the second stiffener 130 is formed to be larger than the region of the door hinge 140.

Accordingly, in the vehicle side structure 100 of the embodiment, when a side collision occurs, the first stiffener 120 extending in the vehicle upper-lower direction Z is able to suppress the deformation amount and the occurrence of cracks or breakage of the pillar 110. In addition, since the lower end of the second stiffener 130 is overlapped with the door hinge 140 in the vehicle width direction X, the load when a side collision occurs can be taken by the second stiffener 130 with a higher rigidity when a side collision occurs. Accordingly, the second stiffener 130 extends to a position above the door hinge 140 and is able to prevent the upper part of the door hinge 140 from being bent or deformed, and is able to form a region that is easy to deform (rigidity difference) at a part below the door hinge 140, that is, a part below the lower end 132 of the second stiffener 130, to ensure that the deformation of the pillar 110 occurs at the lower side. Accordingly, the vehicle side structure 100 according to the embodiment is able to prevent excessive deformation that leads to cracks of the pillar 110.

In addition, in the embodiment, the vehicle side structure 100 further includes a first door beam 150 and a second door beam 160. The first door beam 150 extends in the vehicle front-rear direction Y and is connected with the door hinge 140. The second door beam 160 extends in the vehicle front-rear direction Y, and is bonded to the side surface of the pillar 110 in the vehicle width direction X (e.g., the side surface of the pillar outer member 1140, but the invention is not limited thereto) at a position below the door hinge 140 in the vehicle upper-lower direction Z. From the perspective in the vehicle width direction, the second door beam 160 is away from the second stiffener 130 or overlapped with a portion (not shown) of the second stiffener 130, as long as a part below the second stiffener 130 is easy to deform. In this way, when propagated to the second door beam 160, the load is propagated to and below the second stiffener 130, so that a part below the second stiffener 130 may deform easily. Thus, the deformation amount of the pillar 110 toward the vehicle compartment inner side can be suppressed.

In addition, the vehicle side structure 100 of the embodiment further includes a patch 170. The patch 170 is bonded to the second door beam 160 on the outer side of the pillar 110 in the vehicle width direction X. In addition, the first stiffener 120 further includes a protrusion part 122. The protrusion part 122 protrudes toward the outer side in the vehicle width direction X on the periphery of the patch 170. More specifically, the end part of the second door beam 160 is bonded to the patch 170, and the patch 170 and the protrusion part 122 are both disposed below the door hinge 140. Therefore, the position where the second door beam 160 is bonded to the patch 170 is formed to have higher rigidity, and the rigidity between the second door beam 160 and the second stiffener 130 is formed to be lower to control the deformation to occur at a position between the second door beam 160 and the second stiffener 130. In other embodiments not shown herein, a patch may also be disposed at other positions as appropriate to control the deformation region. The invention is not limited in this regard.

In addition, the lower end 132 of the second stiffener 130 includes a lower surface 132a. The lower surface 132a is formed to be bent toward the inner side of the pillar 110. In addition to further increasing the rigidity of the second stiffener 130 (to render a rigidity difference from the part below the second stiffener 130), the rigidity can be increased without the need to provide an additional component.

In addition, an insertion hole H is provided on a side surface of the pillar 110 in the vehicle width direction X. The insertion hole H is, for example, a hole for a harness (not shown) to pass through. However, the insertion hole H may also be applied for a different purpose, and the invention is not limited thereto. The insertion hole H is formed above the door hinge 140 in the vehicle upper-lower direction Z, and the second stiffener 130 extends to a position above the insertion hole H in the vehicle upper-lower direction Z. In other words, from the perspective in the vehicle width direction X, the second stiffener 130 is overlapped with the insertion hole H, and the region of the second stiffener 130 is formed to be greater than the region of the insertion hole H. Thus, the decrease in rigidity caused by the insertion hole H may be compensated by the second stiffener 130, so as to suppress the deformation in the vicinity of the insertion hole H.

In addition, in the embodiment, the upper part of the first stiffener 120 extends in the vehicle upper-lower direction Z to a roof rail RR extending in the vehicle front-rear direction Y. The lower part of the first stiffener 120 extends in the vehicle upper-lower direction Z to a position below the second door beam 160. With such arrangement, when the vehicle takes a side collision, the second door beam 160 transmits the load to the second stiffener 130. Thus, it is easier to deform and bend at a part below the second stiffener 130 with a higher rigidity.

Referring to FIGS. 1 and 4, in the embodiment, the first stiffener 120 includes a flange part 124. The flange part 124 is disposed above the second stiffener 130 in the vehicle upper-lower direction Z and extends in the vehicle front-rear direction Y. In addition, the flange part 124 is bonded to the pillar inner member 112 and the pillar outer member 114. Specifically, the flange part 124 is bonded by being sandwiched by the pillar inner member 112 and the pillar outer member 114 from the inner side and the outer side in the vehicle width direction X. Therefore, the rigidity of the upper part of the first stiffener 120 is increased by bonding the pillar inner member 112 and the pillar outer member 114, so that a portion at the lower part is easier to be deformed and bent.

Referring to FIG. 5, in the embodiment, the first stiffener 120 includes bonding parts 126. The bonding parts 126 are bonded to the front and rear surfaces of the inner part of the pillar 110 in the vehicle front-rear direction Y. In addition, the bonding part 126 is disposed to be away from the second stiffener 130, such as being away in the vehicle upper-lower direction Z. However, the invention is not limited thereto. From the viewing perspective of the vehicle width direction X, the bonding part 126 is overlapped with the second door beam 160. Accordingly, the rigidity in the vicinity of the second door beam 160 is increased, and the rigidity between the second stiffener 130 and the second door beam 160 is decreased and therefore easier to be deformed and bent.

More specifically, lateral strips B1 are formed on the front and rear surfaces of the first stiffener 120 in the vehicle front-rear direction Y. The lateral strips B1 are disposed above and below the second stiffener 130 and extend in the vehicle width direction X. The lateral strip B1 below the second stiffener 130 includes the bonding part 126. That is, the lateral strips B1 are able to reinforce the rigidity against side collision and increase the difference in rigidity between the region between the second stiffener 130 and the second door beam 160 and other regions, thereby making the region easier to deform. In addition, the lateral strip B1 provided below the second stiffener 130 may also be provided for bonding. An upper strip B2 is formed on a side surface of the first stiffener 120 in the vehicle width direction X. The upper strip B2 is disposed above the second stiffener 130 in the vehicle upper-lower direction Z and extends in the vehicle upper-lower direction Z. In this way, the rigidity of the first stiffener 120 above the second stiffener 130 is increased, and thus the part below the second stiffener 130 is easy to be deformed.

In view of the foregoing, in the vehicle side structure of the invention, when a side collision occurs, the first stiffener extending in the vehicle upper-lower direction is able to suppress the deformation amount and the occurrence of cracks or breakage of the pillar. In addition, since the lower end of the second stiffener is overlapped with the door hinge in the vehicle width direction, the load when a side collision occurs can be taken by the second stiffener with a higher rigidity. Accordingly, the second stiffener extends to a position above the door hinge and is able to prevent an upper part of the door hinge from being bent or deformed and form a region that is easy to deform (rigidity difference) at a part below the door hinge, that is, a lower part at the lower end of the second stiffener, to ensure that the deformation of the pillar occurs at the lower side. In addition, the second door beam is bonded to the side surface of the pillar at a position below the door hinge, so as to further increase the rigidity difference and make the lower part of the second stiffener easy to be deformed. Accordingly, the vehicle side structure according to the invention is able to prevent excessive deformation that leads to cracks of the pillar.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle side structure, comprising:
a pillar, provided on an outer side in a vehicle width direction, extending in a vehicle upper- lower direction, and formed in a hollow structure;
a first stiffener, disposed inside the pillar and extending in the vehicle upper-lower direction;
a second stiffener, disposed inside the pillar and on a lower side in the vehicle upper-lower direction, and having a length in the vehicle upper-lower direction shorter than that of the first stiffener; and
a door hinge, bonded to a side surface of the pillar in the vehicle width direction,
wherein a lower end of the second stiffener in the vehicle upper-lower direction is bonded to the door hinge, and the second stiffener extends in the vehicle upper-lower direction to a position above the door hinge.

2. The vehicle side structure as claimed in claim 1, further comprising:
a first door beam, extending in a vehicle front-rear direction and connected with the door hinge; and
a second door beam, extending in the vehicle front-rear direction, and bonded to the side surface of the pillar in the vehicle width direction at a position below the door hinge in the vehicle upper-lower direction,
wherein, from a viewing perspective in the vehicle width direction, the second door beam is away from or partially overlapped with the lower end of the second stiffener.

3. The vehicle side structure as claimed in claim 2, wherein an upper part of the first stiffener extends in the vehicle upper-lower direction to a roof rail extending in the vehicle front-rear direction, and
a lower part of the first stiffener extends in the vehicle upper-lower direction to a position below the second door beam.

4. The vehicle side structure as claimed in claim 3, wherein the first stiffener comprises bonding parts, the bonding parts are bonded to front and rear surfaces of an inner part of the pillar in the vehicle front-rear direction, and
the bonding parts are disposed to be away from the second stiffener, and, from a viewing perspective in the vehicle width direction, the bonding parts are overlapped with the second door beam.

5. The vehicle side structure as claimed in claim 4, wherein lateral strips are formed on front and rear surfaces of the first stiffener in the vehicle front-rear direction,
the lateral strips are disposed above and below the second stiffener and extend in the vehicle width direction, and
the lateral strips comprise the bonding parts.

6. The vehicle side structure as claimed in claim 4, further comprising:
a patch, bonded to the second door beam on an outer side of the pillar in the vehicle width direction,
wherein the first stiffener further comprises a protrusion part, and the protrusion part protrudes toward an outer side in the vehicle width direction on a periphery of the patch.

7. The vehicle side structure as claimed in claim 3, wherein an upper strip is formed on a side surface of the first stiffener in the vehicle width direction, and
the upper strip is disposed above the second stiffener in the vehicle upper-lower direction and extends in the vehicle upper-lower direction.

8. The vehicle side structure as claimed in claim 3, wherein the first stiffener comprises a flange part, the flange part is disposed above the second stiffener in the vehicle upper-lower direction, and extends in the vehicle front-rear direction,
the pillar comprises a pillar inner member and a pillar outer member, and
the flange part is bonded to the pillar inner member and the pillar outer member.

9. The vehicle side structure as claimed in claim 1,
wherein a side surface of the pillar in the vehicle width direction comprises an insertion hole, and the insertion hole is formed above the door hinge in the vehicle upper-lower direction, and
the second stiffener extends to a position above the insertion hole in the vehicle upper-lower direction.

10. The vehicle side structure as claimed in claim 1, wherein the lower end of the second stiffener comprises a lower surface, and
the lower surface is formed to be bent toward an inner side of the pillar.
